(19) United States
(12) Patent Application Publication
(10) Pub. No.: US 2001/0033226 A1
(43) Pub. Date: Oct. 25, 2001

(54) Advance warning brake light system

(76) Inventors: David H. Levy, Cambridge, MA (US); John R. Howatt, Bedford, MA (US)

Correspondence Address: Arthur D. Little Enterprises, Inc., Acorn Park, Cambridge, MA, 02140, US

(21) Appl. No.: 09/756,072

(22) Filed: Jan. 8, 2001

Related U.S. Application Data
(60) Provisional application No. 60/175,223, filed on Jan. 10, 2000.

(51) Int. Cl. B60Q 1/44

(52) U.S. Cl. 340/479; 340/562; 340/561; 340/552

(57) ABSTRACT

A brake light system is arranged to respond to movement within an r.f. field to provide a signal used to activate the brake light when movement within the r.f. field exceeds a predetermined velocity.

### CROSS-REFERENCE TO RELATED APPLICATION

This application claims the benefit of U.S. Provisional Application No. 60/175,223 filed Jan. 10, 2000.

### BACKGROUND OF THE INVENTION

(1) Field of the Invention

This invention relates generally to vehicle brake light systems and more specifically to means for activating brake light systems.

(2) Description of the Related Art

Many accidents occur when a following vehicle strikes the vehicle ahead of it. It has been appreciated in the prior art that many of these accidents could be prevented, or at least reduced in severity, by activating the brake lights sooner so that the following driver has more time to react. Indeed, at 60 miles per hour, merely half a second of additional reaction time would equate to a following vehicle stopping a dramatic 44 feet sooner. With approximately 1.5 million police-reported rear-end accidents annually in the US, including 900,000 reported injuries and over 1000 fatalities, the benefits of an effective advanced warning system would be extremely significant in both human and monetary terms. However, the prior art has some significant limitations. U.S. Pat. Nos. 5,969,602 and 6,002,329 utilize a single set point (for an optical sensor) to determine when to activate the brake lights in an early warning system. When the driver's foot crosses the set point, the system activates the brake lights in advance of the foot reaching the pedal. One limitation of the approach is that drivers often rest their feet close to the brake, suggesting that the set point should be closer to the brake to avoid erroneous activation of the brake lights. However, at 60 mph each 1/10^{th} of a second of advance warning equates to nearly half a car's length. Therefore, it is advantageous to place the set point as far from the brake as possible. These desires contradict, and the issue becomes one of balancing the risk of erroneous brake light actuation vs. the benefit of increasing the amount of advance warning provided. In any case, the result is compromised performance. Another limitation is related to ergonomics and cost. Many automobile drivers develop a high degree of muscle memory and motion efficiency such that the path traversed by their foot from the gas pedal to the brake pedal is essentially horizontal rather that vertical. The devices disclosed by U.S. Pat. Nos. 5,969,602 and 6,002,239 would require two separate optical sensors to provide advanced warning from both directions, at significant cost. It has also been proposed that an optical sensor be placed into the brake pedal itself, an approach that introduces additional problems, namely, with long-term use abrasions accumulate on the surface of the optics. These abrasions distort the signal and measurably reduce its reliability. It has been suggested to address this problem by recessing the optics within the pedal to isolate the surface optics from the foot, an approach that creates a different long-term problem as dirt and dust accumulates in the recess.

What is desirable is an advanced warning system that actuates automobile brake lights before the driver presses the brake pedal and that operates at long range to sense a foot approaching the brake pedal from a predominantly horizontal attitude, a predominantly vertical attitude, or any angle between, without necessitating the cost of a second sensor. It is further desirable for this system not to actuate brake lights erroneously when a foot merely rests close to the brake pedal. It is yet further desirable to embody these features without the material and labor cost associated with a sensor, or of running a cable to a sensor located at an exposed location. It is yet further desirable to maximize the distance from an object at which the system actuates the brake lights without incurring erroneous actuation. It is yet still further desirable to activate the brake lights to provide early warning to a following driver even prior to the driver realizing he needs to apply the brakes. And finally, it would be desirable to provide an auxiliary emergency signal to the following driver (and/or car) indicating when the driver of the first vehicle intends to stop with unusually high deceleration and also to do so independent of driving conditions such as inclination, ice, snow, etc. This auxiliary emergency signal may be visual, auditory, or may be provided electronically to the following vehicle directly so that it may, in turn, initiate an emergency warning and/or respond to the emergency without intervention by the following driver.

### BRIEF SUMMARY OF THE INVENTION

The present invention is an early warning brake light system comprising a first sensor arranged to generate an r.f. field and an output signal sensitive to movement within the r.f. field. The brake light is activated by means responsive to the first sensor when movement within the r.f. field exceeds a predetermined velocity and direction.

### BRIEF DESCRIPTION OF THE DRAWINGS

These and other objects, features, and advantages of the present invention will become more apparent from the following detailed description of presently preferred embodiments when taken in conjunction with the accompanying drawings wherein:

FIG. 1 is a block diagram of a preferred embodiment of the present invention;

FIG. 2 is a flow chart of a first embodiment of the method according to the present invention;

FIG. 3 is a flow chart of a second embodiment of the method according to the present invention;

FIG. 4 is an embodiment of a segmented capacitor according to the present invention.

### DETAILED DESCRIPTION OF THE INVENTION

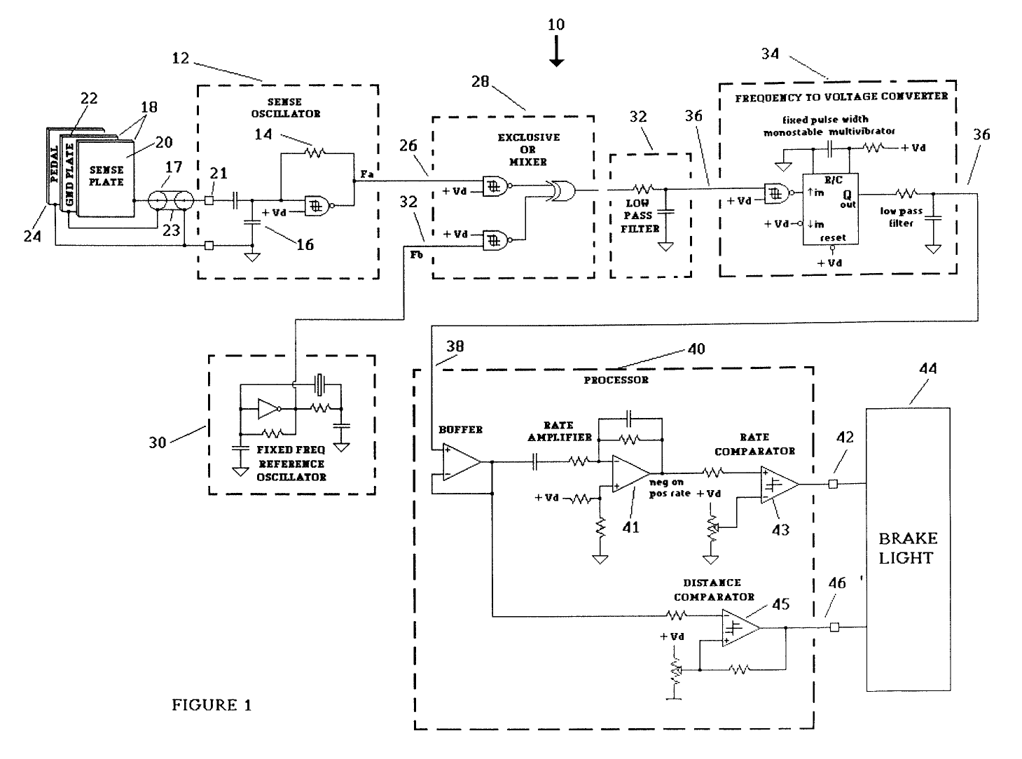

Referring to FIG. 1, there is shown a block diagram of a preferred embodiment of an advance warning brake light system 10. The system includes a sense oscillator 12 which, when activated by a selected DC voltage signal, V_{D}, from a power source (not shown) produces an output alternating voltage signal at a frequency determined by the resonance of the resistance 14 and capacitive elements 16, 18 and the distributed capacitance of cable 17 in the feedback loop of the sense oscillator 12. The capacitor 18 in the feedback loop includes a sense plate 20 and ground plate 22 assembled onto the brake pedal 24 of a vehicle. Alternatively, the capacitor 18 may be mounted below the dashboard of a vehicle and above the brake pedal 24. Cable 17 has one end of a center conductor connected to sense plate 20 and the other end of the center conductor connected to terminal 21 in the feedback loop of the sense oscillator 12. The shielding 23 surrounding the center conductor is connected to ground potential. The capacitor 18 is arranged so that when the sense oscillator 12 is activated, an r.f. field is produced around or near the sense plate 20. The r.f. field is disturbed when a foot of a vehicle driver moves vertically or horizontally toward or away from the sense plate 20, whereby the capacitance of capacitor 18 increases or decreases in proportion to the proximity of the foot to the sense plate 20. In the preferred embodiment, the capacitance of capacitor 18 increases as the foot moves toward the sense plate 20 and decreases as the foot moves away from the sense plate 20. The change in capacitance of capacitor 18 is proportional to the changing distance between the foot and sense plate 20 causing the frequency, Fₐ, of the output voltage signal from the sense oscillator 12 to increase or decrease. In the preferred embodiment, the frequency of the output voltage signal from the sense oscillator 12 decreases by delta F as the foot moves towards the sense plate 20 wherein the decrease in frequency, delta F, is proportional to the distance between the foot and the sense plate 20. The sense plate 20 may be segmented or divided into zones as shown in FIG. 4 and arranged so that the capacitance of capacitor 18 may change differentially as the foot approaches the sense plate 18 to minimize the effect of moisture that might accumulate on the sense plate 20.

The output voltage signal from the sense oscillator 12 at a frequency Fₐ+Delta F is coupled to a first input port 26 of a mixer 28. The output voltage signal from a reference oscillator 30 at frequency F_{b}, is coupled to a second input port 32 of the mixer 28. The mixer 28 is arranged to provide a first output voltage signal at a frequency that is the sum of the frequencies of the first and second input voltage signals, and a second output voltage signal at a frequency that is the difference between the frequencies of the first and second input voltage signals. Therefore, the first output voltage signal from the mixer 28 is at frequency, (Fₐ+delta F)+F_{b} and the second output voltage signal from the mixer is at frequency, (Fₐ+delta F)−F_{b}.

The output voltage signals from the mixer 28 are coupled to a low pass filter 32 arranged to block or attenuate voltage signals at frequencies equal to or exceeding Fₐ+F_{b}. Thus, the output voltage signal from the low pass filter is at frequency (Fₐ+delta F)−F_{b}. The output voltage signal from the low pass filter 32 is coupled as an input signal to a frequency to voltage converter circuit 34 arranged to respond to such input signal to provide an output voltage signal at terminal 36 that is proportional to the distance, d, between a driver's foot and the sense plate 20.

The output voltage signal at terminal 36 of the frequency to voltage converter 34 is coupled to an input port 38 of a processor 40 arranged to include a rate amplifier circuit 41 and a rate comparator circuit 43 connected to generate an electrical rate signal corresponding to the rate or velocity, V_{f}, at which the driver's foot is moving toward the sense plate 20 in response to the signal at terminal 38. The processor 40 generates an output voltage at terminal 42 when the rate signal exceeds a predetermined threshold voltage corresponding to a velocity threshold value, Vₜₕᵣₑₛₕ. The output voltage at terminal 42 is coupled to the brake lights 44 of a vehicle causing them to flash on. If desired, an auxiliary emergency signal may be activated if the foot velocity, V_{f}, exceeds an emergency velocity threshold velocity, Vₑₜₕᵣₑₛₕ. Examples of auxiliary emergency signals are audible warning sounds or visible high-frequency pulsing of traditional brake lights 44, or flashing of a special strobe-like sequence of pulsed bright lights located near the traditional brake lights 44.

A second processing path may be included within processor 40 including a distance comparator circuit 45 arranged to provide an output voltage at terminal 46 which, in turn, is coupled to the brake lights 44. The output voltage at terminal 42 may be logically “anded” with the output voltage at terminal 46 to prevent the brake light 44 from flashing if the foot is moving toward the brake pedal 24 but is still beyond a predetermined distance from the brake pedal 24.

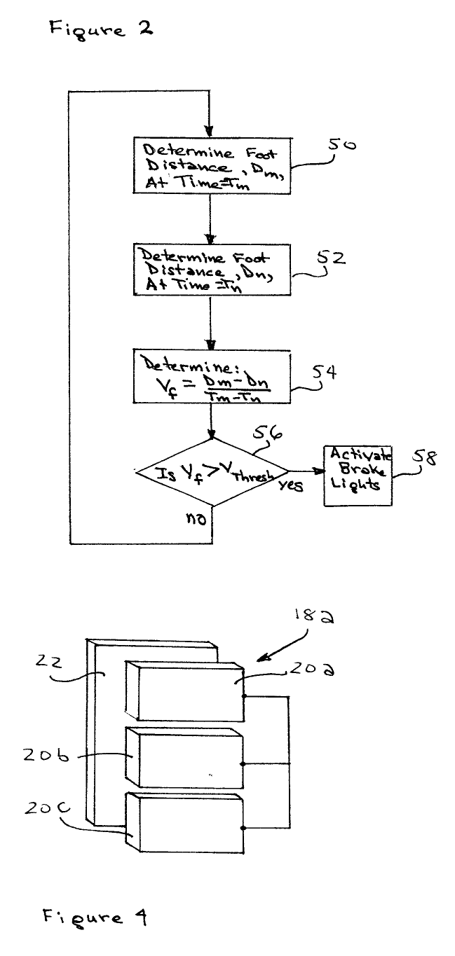

Referring to FIG. 2, there is shown a flowchart of the algorithm of the preferred embodiment arranged to prevent the advance warning brake system 10 from activating the brake light 44 erroneously when a driver's foot rests close to brake pedal 24. In step 50, an electrical signal generated by the frequency to voltage converter 34 provides an indication of the distance, Dₘ, between a driver's foot and the sense plate 20 at time, Tₘ. A relatively short time later, Tₙ, such as 1/500^{th} of a second, another electrical signal is generated by the frequency to voltage converter 34 to provide an indication of the distance, Dₙ, between the driver's foot and the sense plate 20 in step 52. Because absolute values are not required, Dₘ and Dₙ may be determined with any signal value that is proportional to the distance between the sense plate 20 and the foot. In step 54, the velocity of a moving foot, V_{f}, is determined by the arrangements of circuits in processor 40. Various techniques known in the art may be used to eliminate spurious determinations of V_{f} or Dₘ or Dₙ caused by bumps in the road, such as averaging and analyzing adjacent data for continuity. If in step 56, the velocity, V_{f}, of the foot exceeds an experimentally determined velocity threshold value, Vₜₕᵣₑₛₕ, the processor 40 provides an output signal indicating that the driver intends to press the brake pedal 24 in the near future and such signal activates the brake lights 44 in step 58. In another embodiment, the system 10 may be arranged as known in the art to perform a calculation of the second derivative of the distance Dₘ and Dₙ, thereby determining an acceleration of foot movement. If the acceleration of the foot toward the brake pedal 24 exceeds an experimentally determined acceleration threshold value, Aₜₕᵣₑₛₕ, the processor 40 provides an output signal indicating that the driver intends to press the brake pedal 24 in the near future and such signal activates the brake lights 44. Also, because foot size is relatively constant, even a nonsegmented sense plate 20 can provide a sufficient measure of absolute distance of the foot from pedal 24 to implement different velocity thresholds Vₜₕᵣₑₛₕ as a function of distance of the foot from the pedal 24.

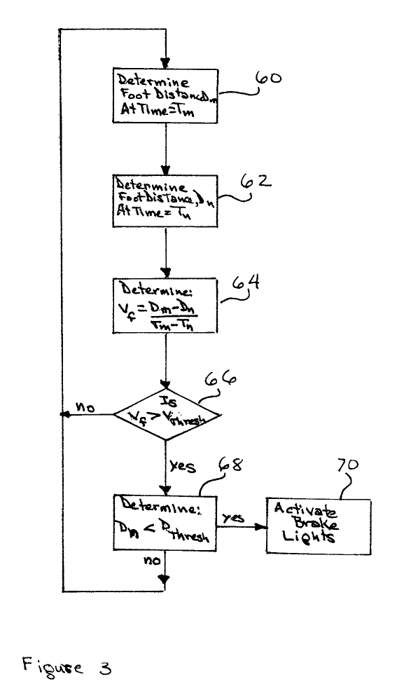

Referring to FIG. 3, there is shown a flow chart of an algorithm of another embodiment arranged to prevent the advance warning brake system 10 from being activated erroneously when a driver's foot is moving toward the brake pedal 24 but is not yet within a predetermined distance to cause the brake lights 44 to flash. In step 60, an electrical signal generated by the frequency to voltage converter 34 provides an indication of the distance, Dₘ, between a driver's foot and the sense plate 20 at the time Tₘ. In step 62, another electrical signal is generated by the frequency to voltage converter 34 to provide an indication of the distance, Dₙ, between the driver's foot and the sense plate 20 at time Tₙ. In step 64, the velocity of a moving foot, V_{f}=Dₘ−Dₘ/Tₘ−Tₙ, is determined by the arrangement of circuits in the processor 40. If, in step 66, the velocity, V_{f}, of the moving foot exceeds an experimentally determined threshold value, Vₜₕᵣₑₛₕ, and if in step 68 the distance, Dₙ, between the driver's foot and the sense plate 20 is less than an experimentally determined threshold distance, Dₜₕᵣₑₛₕ, the processor 40 provides an output signal indicating that the driver intends to press the brake pedal 24 in the near future and such signal activates the brake lights 44 in step 70.

Referring to FIG. 4, there is shown an embodiment of a segmented capacitor 18a having a common ground plate 22 and multiple individual sense plates 20a, 20b, 20c connected in parallel whereby the capacitance of capacitor 18a is determined by the capacitance formed by the individual sense plates 20a, 20b, 20c and ground plate 22. It would be understood by one skilled in the art that segmented capacitor 18a having sense plates 20a, 20b, 20c with unequal surface areas would result in segmented capacitor 18a having zones with unequal capacitance and would aid sense oscillator 12 to linearize the determination of the distance of a driver's foot from the brake pedal 24 in order to improve the accuracy of absolute measurements of such distance. Generally, a driver's foot remains at a relatively constant height relative to the brake pedal. Thus, the use of segmented capacitor 18a having zones of unequal capacitance in the feedback loop of sense oscillator 12 would provide an indication of the angular approach of a driver's foot and an improved determination of absolute distance between the driver's foot and the brake pedal 24. Additional improvement in determining such absolute distance may be achieved by calibrating system 10 with the size of the driver's foot during the first use of the brake pedal 24 to provide a predetermined signal to the brake light 44 when the brake pedal 24 is depressed.

It will be apparent to one skilled in the art that instead of being assembled onto the brake pedal 24, the capacitor 18 could be assembled onto the accelerator pedal, not shown, of a vehicle and system 10 could be arranged to activate the brake light 44 when the velocity of a driver's foot moving off or away from the accelerator pedal exceeds a predetermined threshold velocity, Vₜₕᵣₑₛₕ.

Although the invention has been described and illustrated in detail, it is to be understood that the same is by way of illustration and example, and is not to be taken by way of limitation. The spirit and scope of the present invention are to be limited only by the terms of the appended claims.

What is claimed is:

1. An early warning brake light system comprising:
a sensor generating an r.f. field and an output signal sensitive to movement within the r.f. field; and
means responsive to the sensor output signal for activating the brake light when movement within the r.f. field exceeds a predetermined velocity.

2. An early warning brake light system according to claim 1, wherein the sensor is an oscillator circuit generating an r.f. field around a capacitive element.

3. An early warning brake light system according to claim 2, wherein the capacitance element is assembled onto a brake pedal.

4. An early warning brake light system according to claim 2, wherein the capacitance element is assembled onto the accelerator pedal.

5. An early warning brake light system according to claim 2 wherein the capacitance element is segmented.

6. An early warning brake light system comprising:
a sensor generating an r.f. field and an output signal sensitive to movement within the r.f. field; and
means responsive to the sensor output signal for activating the brake light when movement within the r.f. field exceeds a predetermined velocity and direction.

7. An early warning brake light system according to claim 6, wherein the direction of movement within the r.f. field is toward a brake pedal.

8. An early warning brake light system according to claim 6, wherein the direction of movement within the r.f. field is away from the accelerator pedal.

9. An early warning brake light system comprising:
a sensor generating an r.f. field and an output signal sensitive to movement within the r.f. field; and
means responsive to the sensor output signal for activating the brake light when movement within the r.f. field exceeds a predetermined velocity, distance, and direction.

10. A method of activating an early warning brake light in a vehicle comprising the steps of:
providing an electrical signal indicating displacement, Dₘ, between a vehicle driver's foot and a vehicle brake pedal at time Tₘ;
providing an electrical signal indicating displacement, Dₙ, between a vehicle driver's foot and a vehicle brake pedal at time Tₙ;
determining the velocity of foot movement, V_{f}, between times Tₘ and Tₙ; and
activating the brake light when the velocity, V_{f}, of foot movement exceeds a predetermined threshold velocity, Vₜₕᵣₑₛₕ.

11. A method of activating an early warning brake light in a vehicle according to claim 10, further including the step of activating the brake light when the velocity, V_{f}, of foot movement exceeds a predetermined threshold velocity, Vₜₕᵣₑₛₕ, and the displacement Dₙ, is less than a predetermined threshold distance Dₜₕᵣₑₛₕ.

12. An early warning brake light system comprising:
a sensor generating an electrical signal in response to velocity of movement; and
means responsive to the electrical signal for activating the brake light
